(19) United States
(12) Patent Application Publication
(10) Pub. No.: US 2025/0226624 A1
(43) Pub. Date: Jul. 10, 2025

(54) COAXIAL CONNECTION PROVIDING A PREDETERMINED AXIAL PRESSURE

(71) Applicants: SPINNER GmbH, München (DE); Rohde & Schwarz GmbH & Co. KG, München (DE)

(72) Inventors: Robert Niebauer, Stephanskirchen (DE); Hans-Ulrich Nickel, Neubiberg (DE); Christian Kempter, München (DE); Markus Leipold, München (DE)

(21) Appl. No.: 19/090,149

(22) Filed: Mar. 25, 2025

Related U.S. Application Data
(63) Continuation of application No. PCT/EP2023/078966, filed on Oct. 18, 2023.

(30) Foreign Application Priority Data
Oct. 24, 2022 (EP) 22203315.1

(51) Int. Cl. H01R 24/54; H01R 13/187; H01R 13/622; H01R 103/00

(52) U.S. Cl. CPC H01R 24/542; H01R 13/187; H01R 13/622; H01R 2103/00

(57) ABSTRACT

A coaxial RF connection system includes an external adapter with an external body and therein an external inner conductor. The system further includes an internal adapter with an internal body. The external body has an external body contact surface, and the internal body has an internal body contact surface. The coaxial RF connection system further includes a tensioning means and a spring element. The tensioning means presses—by means of the spring element—the external body against the internal body in a direction of the center axis such that the external body contact surface is in contact with the internal body contact surface. The external body includes an external centering device that is aligned along the center axis with an internal centering device of the internal body.

### CROSS-REFERENCE TO RELATED APPLICATIONS

This US patent application is a continuation of the International Patent Application No. PCT/EP2023/078966 filed on Oct. 18, 2023 and now published as WO 2024/088845, which in turn claims priority of and benefit from the European Patent Application No. EP 22203315.1 filed on October 2022. The disclosure of each of the above-identified patent applications is incorporated herein by reference.

### FIELD OF THE INVENTION

The invention relates to RF coaxial connector and specifically to secure connections with a predefined axial pressure for example in PIM sensitive applications.

### RELATED ART

A millimeter wave connector is disclosed in EP 2876748 A1. Such connectors are normally very small and can be damaged easily. Specifically, connectors at test devices are connected and disconnected many times, such that there is a higher risk of damaging.

### SUMMARY OF THE INVENTION

The problem to be solved by the invention is to provide a coaxial connector, which is comparatively robust and may allow frequent connections and disconnection while maintaining its specified electrical parameters. Solutions of the problem are described in the independent claims. The dependent claims relate to further improvements of the invention.

In an embodiment, an RF connection system including a modular coaxial connector for micro- and millimeter-wave devices such as antennas, filters, splitters, combiners, test and measurement devices is disclosed. It is based on the combination of two adapters—an internal adapter and an external adapter. The internal adapter may be an integral part of a larger device, e.g., a test and measurement device. It may be integrated directly into the housing of an internal microwave component inside of the larger device. The external adapter, which may carry a customer connector, may be screwed onto the device from the outside. It may be exchanged with comparatively low effort.

The motivation for using this double adapter concept is its ability to redirect unwanted tilting and torsional moments that a customer might apply to a fragile external RF connector in the most direct way into a rigid mounting plate inside the device, thus reducing their effects on the electrical performance. Another advantage of the concept is that a fragile external connector that is worn during operation can be replaced simply by replacing the second adapter. The second adapter thus serves as a “port saver”. The dual adapter concept thus goes far beyond concepts with common “field-replaceable” connectors.

This solution provides: a mechanically robust connection, a defined contact force at the contact area, a protection against rotational movements/torques at the contact point, a protection of the contact point against bending moments.

An RF connection system includes an external adapter and an internal adapter which are coupled together by a tensioning means and a spring element.

The external adapter includes an external body and therein an external inner conductor. The external body has an external body contact surface, an external centering device. The external inner conductor defines the center axis and is orthogonal to the external body contact surface.

The internal adapter includes an internal body, and an internal inner conductor. The internal body has an internal body contact surface, and an internal centering device. The internal inner conductor is connected to the external inner conductor.

The tensioning means-which may include a nut or at least one screw-presses, with the use of the spring element, the external body against the internal body in a direction of the center axis to have the external body contact surface be in contact with the internal body contact surface. Due to the presence of the spring element, the contact force is comparatively constant, even with smaller mechanical tolerances of the components or thermal expansion.

The external adapter may include an external coaxial connector outer conductor and coaxially arranged therein within a central bore, the external inner conductor.

The external body may include the external coaxial connector outer conductor. It may further form an outer conductor or may include at least one outer conductor component. In an embodiment, the external body may further include an intermediate outer conductor, which may at least partially enclose the outer conductor component and hold it in a position contacting the external coaxial connector outer conductor. The intermediate outer conductor may be attached to the external base. The intermediate outer conductor may have a thread, which may engage into a thread of external body. Instead of the thread there may be a press fit or a solder connection. The external body may have a hollow bore and may include at least one dielectric spacer to hold the external inner conductor within the external body. The external inner conductor may be centered within a hollow channel of the external body.

The external adapter may further include or be attached to an external coaxial connector. The external coaxial connector may include external coaxial connector outer conductor, external inner conductor, and external coaxial connector nut. Instead of the external coaxial connector nut, there may be a thread for an external nut or any other locking means like a bayonet lock or a snap lock mechanism.

The spring element may include at least one of a coil spring, a disk spring, a stack of disk springs, and an at least elastically deformable material. Multiple disk springs may be mounted in inverted orientations relative to each other to decrease stiffness or they may be mounted in the same orientations to increase stiffness. The tensioning means may be in contact with the spring element, which is further in contact with the external body such that a force to the external body is generated by the tensioning means via the spring element. Further, the spring element may be forming one piece or be monolithic with or integrated into the internal adapter or the external adapter or both. The spring element may be part of the external body and/or the internal body. There may be multiple spring elements present.

The internal adapter includes an internal body, which may form an outer conductor. The internal adapter includes an internal inner conductor at least partially within the internal body. The internal adapter may include at least one dielectric spacer for holding the internal inner conductor within the internal body. In an embodiment, the internal inner conductor is held by the external inner conductor which is supported by dielectric spacers.

The tensioning means may be configured as a nut. Basically, both, the internal adapter and the external adapter have means for releasably tensioning the external adapter to the internal adapter. In the embodiment, the internal body of internal adapter may have an outer tensioning thread which may interface to an inner tensioning thread of tensioning means. Instead of such a tensioning thread, any other suitable means, e.g., a bayonet or a snap mechanism, may be provided. There may be slots or other shapes, e.g., a hexagon which allow to rotate tensioning means by a tool, e.g., a nut or a wrench.

For electrical contact, the internal body has an internal body contact surface which is in contact with an external body contact surface of external body or a component thereof, e.g., intermediate outer conductor. By engaging the tensioning means with the internal body, for example, a force is asserted with the use of of the spring element between the external body and the internal body between the internal body contact surface and external body contact surface, orthogonally to those surfaces. This contact pressure can be well defined by mechanical dimensions and a spring constant of the spring element and is reproducible over multiple lock and release cycles of the adapters.

The internal body may further have an internal centering device that allows axially movement when engaged with external centering device, such that it does not change the contact force applied via the spring element. The centering device may be a bore, e.g., a cylindrical bore or recess, in the internal body that interfaces to or with a matching external centering device (configured, e.g., as a cylindrical part, protrusion, or shaft) of the external body. In the alternative, this situation may be reversed, such that the external body has a bore or a matching part of the internal body. Further, there may be present a rotation blocking feature to block rotation of the external adapter against the internal adapter. Such rotational blocking feature may be structured as a protrusion at the external body, e.g., the intermediate outer conductor at the external body and that matches with nd/ot dimensionally fits into a groove of the internal body.

For electrical contact between the internal inner conductor and the external inner conductor, the internal inner conductor may have an internal inner conductor contact pin that may match to an external inner conductor contact spring. In an alternating embodiment, the presence of pin and the springs are reversed between the inner conductors.

Further, there may be present a connecting element between the tensioning means and an external base being part of the external body for a lose coupling without interfering with the spring. This configuration may allow to retract the external adapter in a direction opposing to the spring load direction. In one specific case, such connecting element may be a configured as a scaling ring.

In an embodiment, a flange may be attached to the internal body. The flange may be configured to mount the RF connection system to a housing.

In order to prevent a customer from removing an external adapter, the screws or any locking means of the external adapter may be covered by a cover rosette. This rosette is to be destroyed when removed, so that a sealing function is given.

### BRIEF DESCRIPTION OF THE DRAWINGS

In the following the invention will be described by way of example, without limitation of the general inventive concept, on examples of embodiment with reference to the drawings.

FIG. 1 shows a first embodiment in a sectional view.

FIG. 2 shows the first embodiment in a side view.

FIG. 3 shows the first embodiment in a front view.

FIG. 4 shows the first embodiment in a rear view.

FIG. 5 shows the first embodiment in a further sectional view A-A.

FIG. 6 shows the first embodiment in a further sectional view B-B.

FIG. 7 shows the first embodiment in a total view.

FIG. 8 shows a modified embodiment with a flange.

FIG. 9 shows the modified embodiment from a rear side.

FIG. 10 shows a second embodiment with integrated spring element.

FIG. 11 shows a sectional view of the second embodiment.

FIG. 12 shows a further embodiment with integrated spring element.

FIG. 13 shows an alternate embodiment of the external adapter.

FIG. 14 shows a sectional view of the embodiment with integrated spring element.

### DETAILED DESCRIPTION

In FIG. 1 a first embodiment is shown in a sectional view though its center axis 110. An RF connection system 100 includes an external adapter 200, an internal adapter 300 which is coupled to the external adapter 200, a tensioning means 230, and a spring element 250.

The external adapter 200 includes an external body 260 and therein an external inner conductor 210. The external body 260 has an external body contact surface 224, an external centering device 222. The external inner conductor 210 defines the center axis 110 and is orthogonal to the external body contact surface 224.

The internal adapter 300 includes an internal body 320, and an internal inner conductor 310. The internal body 320 has an internal body contact surface 324, and an internal centering device 322. The internal inner conductor 310 is connected to the external inner conductor 210.

The tensioning means 230 presses by means of the spring element 250 the external body 260 against the internal body 320 in a direction of the center axis 110, such that the external body contact surface 224 is in contact with the internal body contact surface 324.

The external adapter 200 may include an external coaxial connector outer conductor 220 and coaxially arranged therein within a central bore, the external inner conductor 210.

The external body 260 may include the external coaxial connector outer conductor 220. It may further form an outer conductor or may include at least one outer conductor component 245. In the specific embodiment, the external body 260 further includes an intermediate outer conductor 248, which may at least partially enclose the outer conductor component 245 and hold it in a position contacting the external coaxial connector outer conductor 220. The intermediate outer conductor 248 may be attached to the external base 240. The intermediate outer conductor 248 may have a thread 249 which may engage into a thread 241 of external body 260. The external body 260 may have a hollow bore and include at least one dielectric spacer to hold the external inner conductor 210 within the external body 260.

The external adapter 200 may further include or be attached to an external coaxial connector. This may include external coaxial connector outer conductor 220, external inner conductor 210, and external coaxial connector nut 225. Instead of the external coaxial connector nut 225, there may be a thread for an external nut or any other locking means like a bayonet lock or a snap lock mechanism.

and an external coaxial connector nut 225 or a coupling thread (not shown) for coupling a RF connector to the external adapter 200.

The spring element 250 may include at least one of a coil spring, a disk spring, a stack of disk springs or an at least elastically deformable material. Multiple disk springs may be mounted in inverted orientations relative to each other to decrease stiffness or they may be mounted in the same orientations to increase stiffness. The tensioning means 230 may be in contact with the spring element 250, which is further in contact with the external body 260 such that a force to the external body 260 is generated by the tensioning means 230 via the spring element 250.

The internal adapter 300 includes an internal body 320 which may form an outer conductor. The internal adapter 300 includes an internal inner conductor 310 at least partially within the internal body 320. The internal adapter 300 may include at least one dielectric spacer for holding the internal inner conductor 310 within the internal body 320. In an embodiment as shown herein, the internal inner conductor 310 is held by the external inner conductor 210 which is supported by dielectric spacers 226 and 228.

The tensioning means 230 may be a nut. Basically, both, the internal adapter 300 and the external adapter 200 have means for releasably tensioning the external adapter 200 to the internal adapter 300. In the embodiment shown herein, the internal body 320 of internal adapter 300 may have an outer tensioning thread 323 which may interface to an inner tensioning thread 233 of tensioning means 230. Instead of such a tensioning thread, any other suitable means, e.g., a bayonet or a snap mechanism, may be provided. There may be slots 238 or other shapes, e.g., a hexagon which allow to rotate tensioning means 230 by a tool, e.g., a nut or a wrench.

For electrical contact, the internal body 320 has an internal body contact surface 324 which is in contact with a external body contact surface 224 of external body 260 or a component thereof, e.g., intermediate outer conductor 248. By engaging the tensioning means 230 e.g., with the internal body 320, a force is asserted by means of the spring element 250 between the external body 260 and the internal body 320 between the internal body contact surface 324 and external body contact surface 224, orthogonally to those surfaces. This contact pressure can be well defined by mechanical dimensions and a spring constant of the spring element 250 and is reproducible over multiple lock and release cycles of the adapters.

The internal body 320 may further have an internal centering device 322 which allows axially movement when engaged with external centering device 222, such that it does not change the contact force applied via the spring element 250. The internal centering device 322 may be a bore, e.g., a cylindrical bore or recess, in the internal body 320 which interfaces to a matching external centering device, e.g., cylindrical part or shaft, of the external body. Further, this may be reversed, such that the external body has a bore or a matching part of the internal body 320. Further, there may be a rotation blocking feature to block rotation of the external adapter 200 against the internal adapter 300, e.g., a protrusion 261 or intermediate outer conductor 248 at external body 260 which matches into a groove 361 of internal body 320.

For electrical contact between the internal inner conductor 310 and the external inner conductor 210, the internal inner conductor 310 may have an internal inner conductor contact pin 312 which may match to an external inner conductor contact spring 212. In an alternating embodiment, the pin and the springs are reversed between the inner conductors.

Further, there may be a connecting element 270 between the tensioning means 330 and an external base 240 being part of the external body 260 for a lose coupling without interfering with the spring. This may allow to retract the external adapter in a direction opposing to the spring load direction. This connecting element may be a sealing ring.

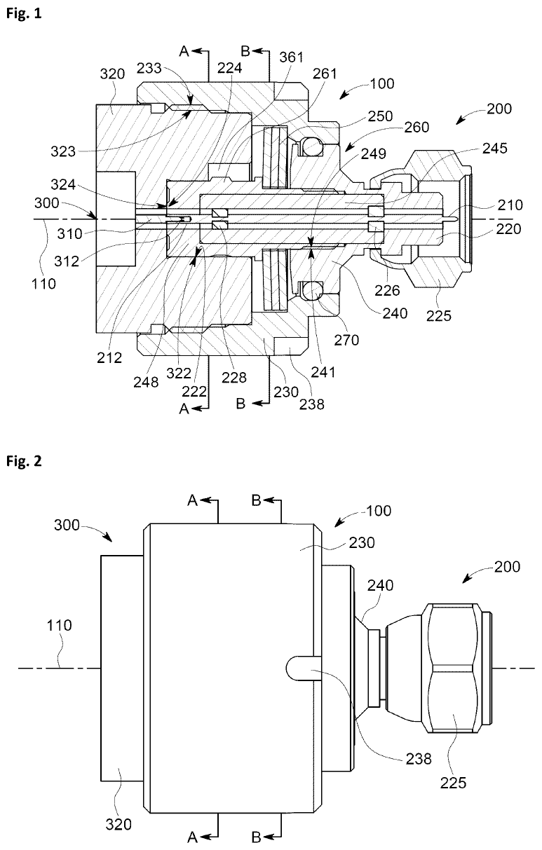

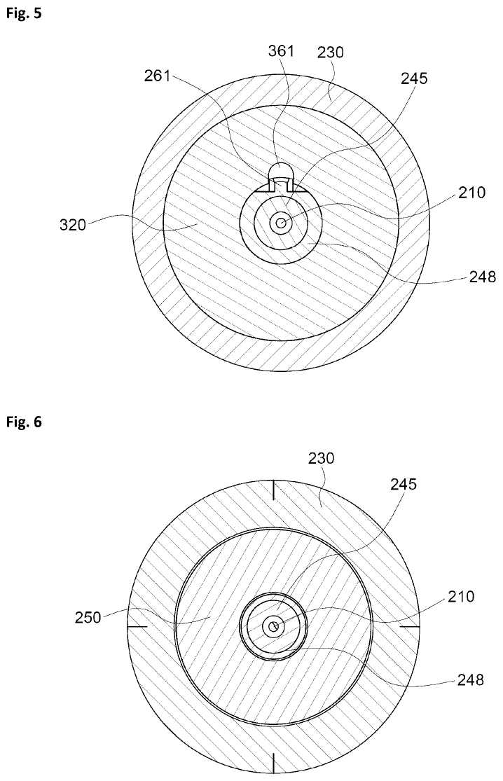

In FIG. 2 the first embodiment is shown in a side view. This figure shows a center axis 110 and section marks A-A, B-B marking the sections of FIGS. 5 and 6.

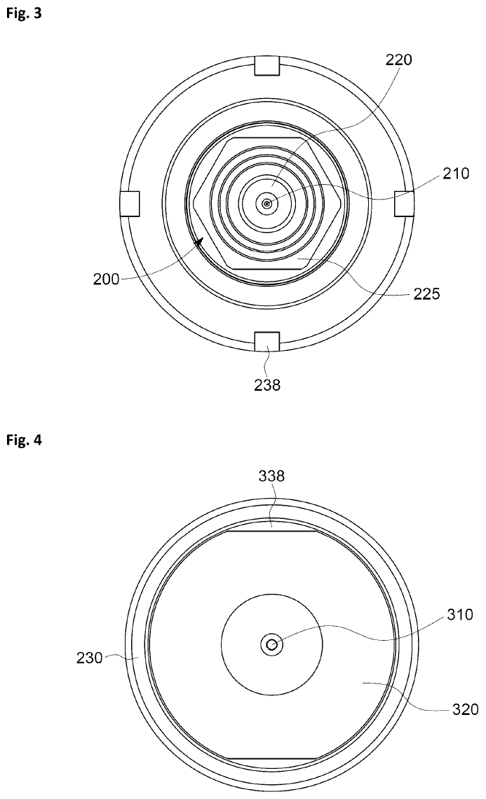

FIG. 3 shows the first embodiment in a front view from the side of the external adapter 200.

FIG. 4 shows the first embodiment in a rear view from the side of the internal adapter 300. There may be flat portions 338 for rotating the internal body 320 by a tool, e.g., a nut or a wrench.

FIG. 5 shows the first embodiment in a sectional view as marked A-A in FIGS. 1 and 2. It shows a section through the protrusion 261 guided in the groove 361 to block a rotation of the external adapter 200 against the internal adapter 300.

FIG. 6 shows the first embodiment in a sectional view as marked B-B in FIGS. 1 and 2. This figure shows a top view on the spring element 250.

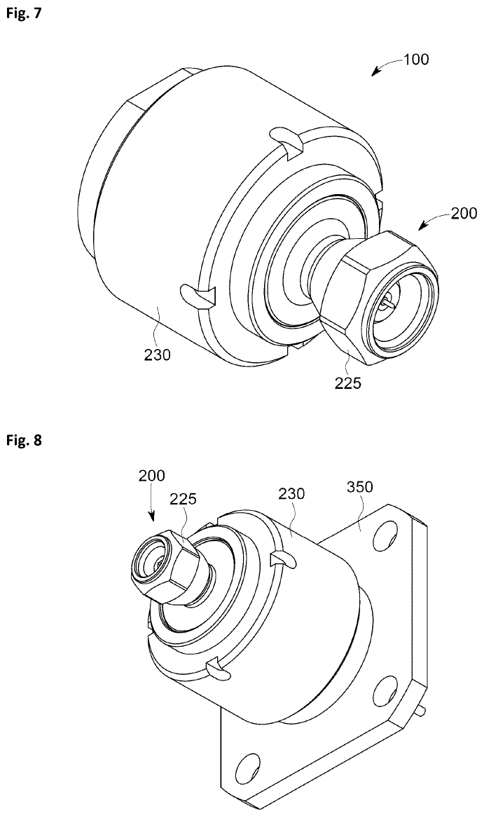

In FIG. 7 the first embodiment is shown in a total view.

FIG. 8 shows a modified embodiment from a front side with a flange 350 attached to the internal body 320. The flange may be configured to mount the RF connection system to a housing (not shown).

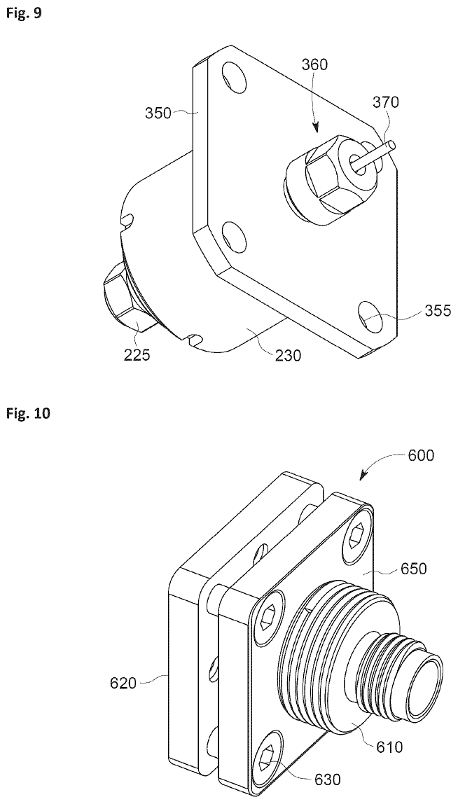

FIG. 9 shows the modified embodiment from a rear side. Here, a cable connector 360 with a coaxial cable 370, e.g., a semi rigid-line may be provided. It may be attached to a housing, e.g., by screws through mounting holes 355. In another embodiment (not shown), a coaxial connector may be provided at the internal body 320.

FIG. 10 shows a second embodiment 600 with integrated spring element. It has an external adapter 610, and an internal adapter 620, which are held together by tensioning screws 630, e.g., 4 screws.

FIG. 11 shows a sectional view of the embodiment 600 with integrated spring element. Here, the external body 650, which may have a shape of a flange, which is part of or connected to the external adapter 610, is the spring element. The spring element and the external adapter 610 are one piece. In another embodiment, the spring element and the internal adapter 620 may be one piece. Also, both adapters may be spring elements. When the tensioning screws 630 are tightened, the external body 650 will be slightly elastically deformed, as indicated exaggerated. As no separate spring is required, this embodiment uses less parts, is cheaper in manufacturing and can easier be assembled.

An electrical contact is established between the external body contact surface 655 and the internal body contact surface 665. Centering is done by internal centering device 622, which may be a cylindrical protrusion or shaft of the internal adapter 620, and which fits into or matches to external centering device 612, which may be a cylindrical recess of the external adapter 610. Shaft and recess may be exchanged. Rotation is blocked by the tensioning screws 630. An external inner conductor 670 is within the external body 650 and an internal inner conductor 680 is within the internal body 660 of internal adapter 620.

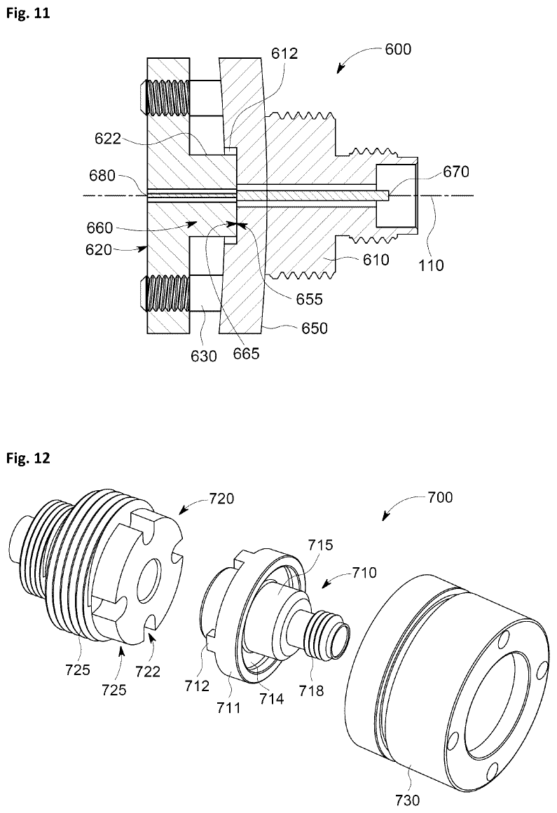

FIG. 12 shows a further embodiment 700 with integrated spring element. It includes an external adapter 710 and an internal adapter 720 which are held together by a tensioning nut 730.

The external adapter has an external body 715 which may have a thread 718 configured to hold a tensioning nut of an external cable or line. It may also have a tensioning nut. Further, a pressure ring 711 connected to the external body 715 by a spring element 714 (connecting section). The external body 715 is forming one part with the spring element 714 and the external body 715. The pressure ring 711 may have at least one protrusion 713.

The internal adapter 720 includes an outer thread 726 for the tensioning nut 730 and recesses 723 matching to the protrusions 713 of the external adapter 710. When the protrusions 713 are seated in the recesses 723, the external adapter 710 can no more rotate against the internal adapter 720.

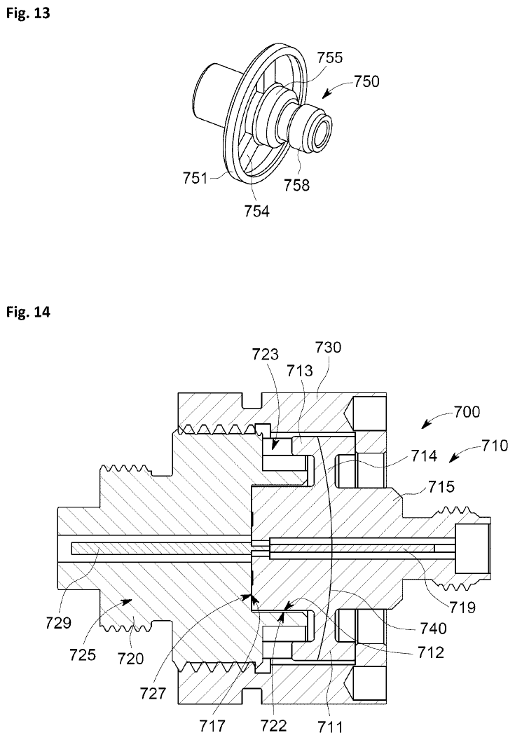

FIG. 13 shows an alternate embodiment 750 of the external adapter. It has a pressure ring 751 which is connected by connecting rods 754 or spokes to a body 755, forming one part with the body. Further, a thread 758 for an external adapter may be provided.

FIG. 14 shows a sectional view of the embodiment 700 with integrated spring element. It shows how the tensioning nut 730 pressed against the pressure ring 711. A defined force is generated between the external adapter 710 and the internal adapter 720 at an external body contact surface 717 by an elastic deformation of the external adapter and specifically the spring element 714. The line 740 indicates this deformation in an exaggerated way. There is an external inner conductor 719 and an external inner conductor 729. The internal adapter 720 has an internal body 725. An external body contact surface 717 contacts an internal body contact surface 727. An external centering device 712 matches with an internal centering device 722 for centering.

### LIST OF REFERENCE NUMERALS

100 RF connection system
110 center axis
200 external adapter
210 external inner conductor
212 external inner conductor contact spring
220 external coaxial connector outer conductor
222 external centering device
224 external body contact surface
225 external coaxial connector nut
226 dielectric spacer
228 dielectric spacer
230 tensioning means
232 inner tensioning thread
238 slot for key
240 external base
241 thread
245 outer conductor component
248 intermediate outer conductor
249 thread
250 spring element e.g., disc springs
260 external body
261 protrusion
270 connecting element
300 internal adapter
310 internal inner conductor
312 internal inner conductor contact pin
320 internal body
321 rigid connection e.g., press connection
322 internal centering device
323 outer tensioning thread
324 internal body contact surface
338 flat portion
355 mounting holes
360 cable connector
370 coaxial cable
361 groove
600 embodiment with integrated spring element
610 external adapter
612 external centering device
620 internal adapter
622 internal centering device
630 tensioning screws
650 external body
655 external body contact surface
660 internal body
665 internal body contact surface
670 external inner conductor
680 internal inner conductor
700 further embodiment with integrated spring element
710 external adapter
711 pressure ring
712 external centering device
713 protrusion
714 spring element
715 external body
717 external body contact surface
718 thread for external adapter
719 external inner conductor
720 internal adapter
722 internal centering device
723 recess
725 internal body
726 outer thread
727 internal body contact surface
729 internal inner conductor
730 tensioning nut
740 line of deformation
750 alternate external adapter
751 pressure ring
754 connecting rods
755 body
758 thread for external adapter

1. A coaxial RF connection system comprising:
an external adapter that includes an external body and an external inner conductor inside the external body,
wherein the external body has an external body contact surface, and,
wherein the external inner conductor defines a center axis and is orthogonal to the external body contact surface,
an internal adapter that includes an internal body having an internal body contact surface, and
an internal inner conductor, wherein the internal inner conductor is connected to the external inner conductor,
a tensioning means, and
a spring element,
wherein the tensioning means is configured to press, using the spring element, the external body against the internal body in a direction of the center axis to form contact between the external body contact surface and the internal body contact surface, and
wherein the external body comprises an external centering device which is aligned along the center axis with an internal centering device of the internal body.

2. A coaxial RF connection system according to claim 1, wherein the spring element includes at least one of a coil spring, a disk spring, a stack of disk springs, and an elastically deformable material.

3. A coaxial RF connection system according to claim 1, wherein the spring element is integrated and/or monolithic with the external adapter and/or with the internal adapter.

4. A coaxial RF connection system according to claim 1, further comprising a rotation blocking structural feature configured to block a rotation of the external adapter against the internal adapter.

5. A coaxial RF connection system according to claim 4, wherein the rotation blocking structural feature comprises at least one protrusion matching into a grove.

6. A coaxial RF connection system according to claim 1, wherein the external adapter includes an external coaxial connector comprising an external coaxial connector outer conductor and the external inner conductor.

7. A coaxial RF connection system according to claim 6, wherein the external body comprises an external base that forms part of the external coaxial connector outer conductor.

8. A coaxial RF connection system according to claim 7, wherein the external body comprises an intermediate outer conductor attached to the external base.

9. A coaxial RF connection system according to claim 8, wherein the spring element is seated on the intermediate outer conductor.

10. A coaxial RF connection system according to claim 1, wherein the tensioning means is a nut.

11. A coaxial RF connection system according to claim 1, further comprising at least one of a cable connector with a coaxial cable and a coaxial connector at the internal body.

12. A coaxial RF connection system according to claim 1, wherein the external centering device comprises a cylindrical protrusion and the internal centering device comprises a matching cylindrical recess, or
wherein the external centering device comprises a cylindrical recess and the internal centering device comprises a matching cylindrical protrusion.
